(19) United States
(12) Patent Application Publication
(10) Pub. No.: US 2013/0286700 A1
(43) Pub. Date: Oct. 31, 2013

(54) Zero-Standby Current Switch for Control of a Power Converter

(71) Applicants: Kaochi Im, Bothell, WA (US); Kedar V. Bhatawadekar, Santa Clara, CA (US); Jianhua Chen, Sunnyvale, CA (US); Matthew P. Galla, Holly Springs, NC (US); Patrick J. Hibbs, Murphy, TX (US)

(72) Inventors: Kaochi Im, Bothell, WA (US); Kedar V. Bhatawadekar, Santa Clara, CA (US); Jianhua Chen, Sunnyvale, CA (US); Matthew P. Galla, Holly Springs, NC (US); Patrick J. Hibbs, Murphy, TX (US)

(73) Assignee: Tyco Electronics Corporation, Berwyn, PA (US)

(21) Appl. No.: 13/456,100

(22) Filed: Apr. 25, 2012

(51) Int. Cl. H02M 7/06

(52) U.S. Cl. 363/126

(57) ABSTRACT

A controller circuit for activating and deactivating an electrical power converter that provides power to a device includes power input terminals on a primary side, and power output terminals on a secondary side, which are configured to provide power to the device. The controller circuit includes a detection circuit configured to determine whether the device is connected and, if connected, causes power to be routed to the electrical power converter to activate the electrical power converter. When the device is not detected, the electrical power converter is deactivated until the device is reconnected.

### BACKGROUND

1. Field

This application relates generally to power adapters for powering a device, and more particularly to a power adapter that has essentially zero-standby current when the device is not connected to the power adapter.

2. Description of Related Art

Portable devices such as phones, mp3 players, and the like are typically sold with dedicated charges for recharging batteries stored within. The power adapters usually plug into an AC outlet receptacle and convert AC line voltage into a much lower DC voltage suited for the portable device. For example, 120 VAC line voltage may be down-converted to 5 volts DC.

A typical power adapter may be tethered to the device via a cable that includes two or more conductors. A connector at one end of the cable facilitates attachment of the cable to the device. The connector typically includes several terminals, one for each conductor in the cable. Power and ground terminals may be utilized to deliver power to the device. A third terminal may be coupled to a shield in the cable that is wrapped around the two power conductors to minimize EMI radiation. The shield terminal is usually shorted to the ground terminal within the device.

In some instances, a fourth conductor and terminal may be used to communicate information about the power adapter to the device. For example, the device may determine the type of power adapter based on an impedance or voltage presented on the fourth line. The impedance may be the resistance of a pull-up resistor or pull-down resistor within the power adapter. The voltage may be the voltage present between resistors of a voltage divider circuit in the power adapter. The value of the impedance or voltage may indicate, for example, whether the power adapter is a fast power adapter or a slow power adapter, which is typically determined according to an amount of current the power adapter can supply. The device may alter its charging scheme based on an amount of current available for charging. To minimize pin count, the device terminal to which the fourth terminal is coupled may be configured to serve multiple purposes. For example, the device terminal may correspond to a data line terminal of the device, such as a D+ or D− terminal of a Universal Serial Bus (USB). The device may use one of the data lines for detecting the type of power adapter and for communicating data when the device is coupled to a computer.

To minimize the size of the power adapter and to improve charge efficiency, most power adapters utilize some form of switching regulator. These switching regulators are able to obtain conversion efficiencies in the ninety percent range. That is, ninety percent of the power coming into the power adapter is delivered to the portable device when it is connected. The power adapter dissipates the rest in the form of heat.

However, even when a device is not connected to the power adapter, the internal regulator maintains voltage on the power terminals. In other words, the power adapter is still consuming some amount of standby power to maintain voltage regulation. For example, a typical device power adapter may draw around 200 mW when not connected to a device.

### BRIEF DESCRIPTION

In a first aspect, an electrical power converter includes a first line terminal and a second line terminal configured to be coupled to first and second lines, respectively, of a power source. The electrical power converter also includes a switch circuit, electrical power converter circuit, and detection circuit. The switch circuit includes a first terminal and a second terminal. The first terminal is in electrical communication with the second line terminal. The switch circuit is configured to selectively route current from the first terminal to the second terminal based on a device detection signal. The electrical power converter circuit includes a primary side and a secondary side. The primary side includes a power input terminal that is in electrical communication with the first line terminal, and a primary ground terminal that is in electrical communication with the second terminal of the switch. The secondary side includes a power output terminal and a secondary ground terminal that are configured to provide power to a device via power and ground terminals of the device. The detection circuit is configured to determine whether the device is connected and, if connected, generates the device detection signal to thereby cause current to flow via the switch circuit to the electrical power converter to activate the electrical power converter circuit. When the device is not detected, the instantaneous power of the electrical power converter does not exceed 2 mW.

In a second aspect, a system includes a device and a power adapter for powering the device. The power adapter includes an electrical power converter configured to power the device, and a controller circuit configured to activate and deactivate the electrical power converter based on a detection signal. The power adapter also includes a detection circuit configured to determine whether the device is connected to the power adapter and, if connected, generates the detection signal to thereby cause the controller circuit to activate the electrical power converter. When the device is not detected, the electrical power converter circuit is not activated until the device is reconnected

In a third aspect, a controller circuit for activating and deactivating an electrical power converter that provides power to a device is provided. The electrical power converter includes a power input terminal and primary ground terminal on a primary side, and a power output terminal and a secondary ground terminal on a secondary side, which are configured to provide power to the device via power and ground terminals of the device. The controller circuit includes a first line terminal and a second line terminal configured to be coupled to first and second lines, respectively, of a power source. The controller circuit also includes a switch circuit and a detection circuit. The switch circuit includes a first terminal and a second terminal. The first terminal is in electrical communication with the second line terminal, and the second terminal is in electrical communication with the primary ground terminal of the electrical power converter. The switch circuit is configured to selectively route current from the first terminal to the second terminal based on a device detection signal. The detection circuit is configured to determine whether the device is connected and, if connected, generates the device detection signal to thereby cause current to flow via the switch circuit to the electrical power converter to activate the electrical power converter. When the device is not detected, the electrical power converter circuit is deactivated.

In a fourth aspect, a controller circuit for activating and deactivating an electrical power converter that provides power to a device is provided. The electrical power converter includes power input terminals on a primary side, and power output terminals on a secondary side, which are configured to provide power to the device. The controller circuit includes a detection circuit configured to determine whether the device is connected and, if connected, cause power to be routed to the electrical power converter to activate the electrical power converter. When the device is not detected, the electrical power converter is deactivated until the device is reconnected.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 is a system that includes a portable device and power adapter;

FIG. 2 is an exemplary schematic representation of the power adapter;

FIG. 3 illustrates an exemplary embodiment of a power adapter that includes a controller circuit that may correspond to a controller circuit illustrated in FIG. 2;

FIG. 4 is an exemplary schematic representation of a first controller circuit embodiment that may correspond to the controller circuit illustrated in FIG. 3;

FIG. 5 is an exemplary schematic representation of a second controller circuit embodiment that may correspond to the controller circuit in FIG. 3;

FIG. 6 is an exemplary schematic representation of a switch circuit that may be utilized in connection with the circuit illustrated in FIG. 5; and

FIG. 7 is an exemplary schematic representation that illustrates detection current flow via a converter.

### DETAILED DESCRIPTION

The embodiments described below overcome the problems of standby power discussed above by utilizing a controller circuit that determines whether a device is connected to a power adapter. When a device is connected, the controller circuit activates an electrical power converter of the power adapter by routing line voltages to the converter. When the device is disconnected, the controller circuit interrupts current flow to the converter to deactivate the converter. In the deactivated state, the converter draws essentially zero power.

The controller circuit is configured to detect the presence of the device via a third terminal, such as a shield terminal or data terminal, rather than via a sense resistor in series with the power line to the device, which is less efficient.

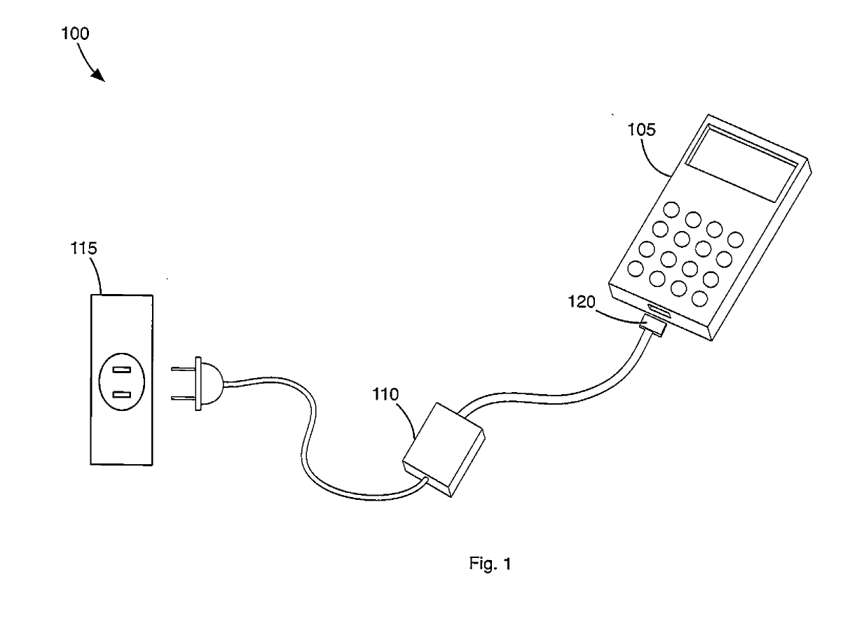

FIG. 1 is a system 100 that includes a portable device 105 and a power adapter 110. The portable device 105 may correspond to any portable device that derives power from a rechargeable battery (not shown) such as a mobile phone, mp3 player, camera, etc. The rechargeable battery may be a nickel-cadmium (NiCd), nickel metal hydride (NiMH), or lithium (Li) battery, or a battery based on a different chemistry.

The power adapter 110 is configured to communicate power to the device to facilitate charging of the rechargeable battery. In one implementation, the power adapter 110 is configured to recharge the battery while it is in the portable device 105. In this regard, the power adapter 110 may include a cabled connector 120 configured to attach to the device 105. The connector 120 may include several terminals including power and ground terminals through which power is provided, terminals that are coupled to a shield of the cable, and data line terminals that allow the device 105 to determine the type of power adapter 110.

The power adapter 110 may derive power from a power source 115 such as a power outlet in the home, automobile lighter adapter, generator, etc. The power adapter 110 may be configured to provide isolation between the power source 115 and the connector 120. That is, the ground terminal of the connector 120 may be floating with respect to the first and second lines of the power source 115.

While a separate power adapter 110 and device 105 are illustrated, it is understood that features of the power adapter, as set forth in more detail below, may be wholly or partially incorporated within the device. In addition, while many devices include battery charging circuitry configured to charge a rechargeable battery, it is understood that the similar charging circuitry may be incorporated within the power adapter 110 to facilitate direct charging of a battery by the power adapter 110 without the need for the device 105.

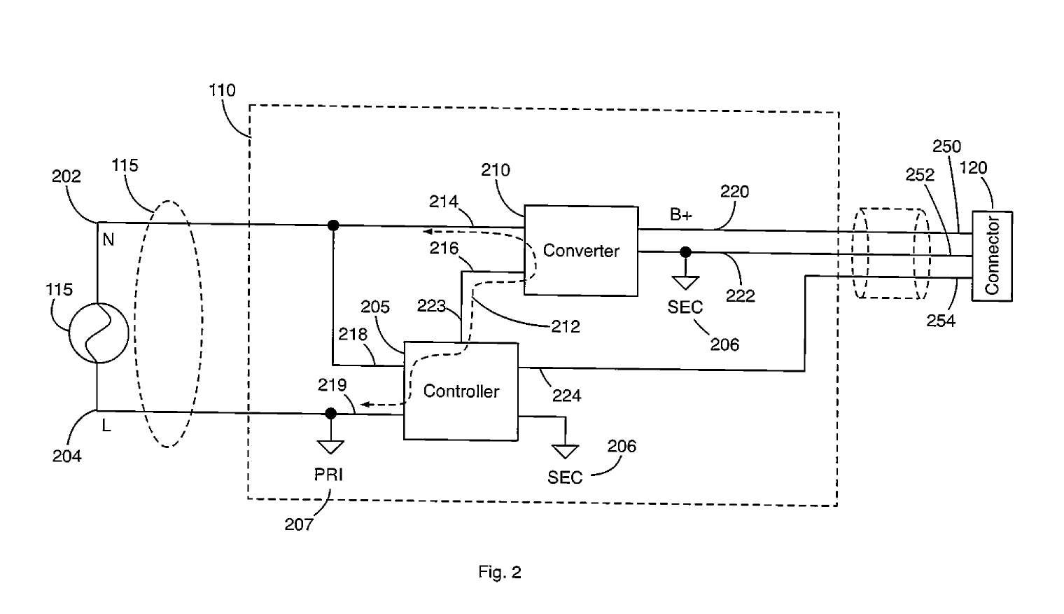

FIG. 2 is a schematic representation of the power adapter 110. Referring to FIG. 2, the power adapter 110 includes a controller circuit 205 and a converter 210. The converter 210 may correspond to an electrical power converter configured to convert voltage from the power source 115 to a different voltage suited for a particular device 105. For example, the converter 210 may be an AC-DC converter for converting household line voltages to relatively low DC voltages. The converter 210 may be a switching type of voltage regulator that provides isolation between primary side terminals (214, 216) and secondary side terminals (220, 222). For example, the converter 210 may incorporate a magnetic device such as a transformer to isolate the respective terminals. Voltages on the primary side are referenced to a primary ground 207. Voltages on the secondary side are referenced to a secondary ground 206.

A second line terminal 214 and first line terminal 216 on the primary side of the converter 210 may be in electrical communication with a second line 202 of the power source 115 and an output terminal 223 of the controller circuit 205, respectively. A power output terminal 220 and ground terminal 222 on the secondary side of the converter 210 may be in electrical communication with power and ground terminals (250, 252) of the connector 120. The power and ground terminals (250, 252) of the connector 120 are configured to be coupled to power and ground terminals, respectively, of the device 105.

The controller circuit 205 includes a first line terminal 219 and a second line terminal 218 that are in electrical communication with the first line 204 and the second line 202, respectively, of the power source 115. The controller circuit 205 also includes a detection terminal 224 for detecting the presence of a device 105. The controller detection terminal 224 is in electrical communication with a connector detection terminal 254. The connector detection terminal 254 may be configured to be coupled to a shield terminal, data terminal, or different terminal of the device 105 to facilitate detection of the device 105.

In operation, the controller circuit 205 routes converter current 212 from the first line terminal 219 to the output terminal 223 when a device 105 is detected via the controller detection terminal 224. When the device 105 is removed, the controller circuit 205 detects the removal via the controller detection terminal 224 and subsequently disables the converter 210 by blocking the converter current 212. While some leakage current may flow through the power adapter 110 when no device 105 is connected, the leakage current is insignificant such that the instantaneous power consumed by the power adapter 110 is below 2 mW, below 500 μW, and preferably below 100 μW. When disabled, the voltage across the power output terminals (220-222) is substantially zero volts.

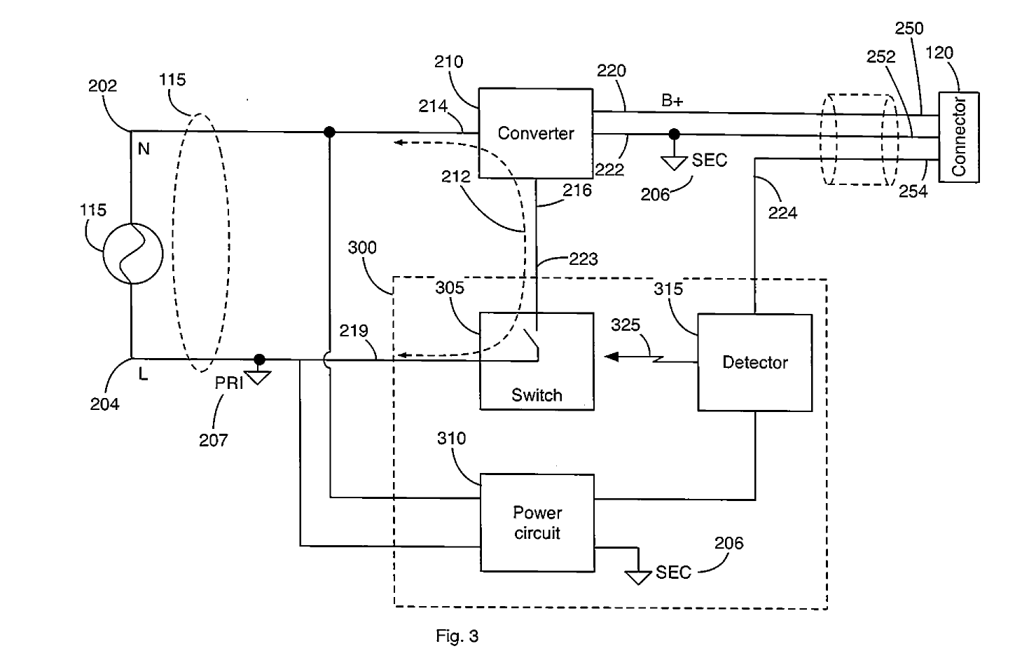

FIG. 3 is an exemplary embodiment of a controller circuit 300 that may correspond to the controller circuit 205, described above. Referring to FIG. 3, the controller circuit 300 includes a switch circuit 305, a power circuit 310, and a detector circuit 315. The power circuit 310 is configured to convert voltage from the power source 115 to a voltage suitable for operation of the detector circuit 315. In this regard, the voltage provided to the detector circuit 315 may be isolated from the voltage of the power source 115.

The detector circuit 315 is configured to determine whether the device 105 is coupled to the connector 120 and, if detected, generate a device detection signal 325. The device detection signal 325 is communicated to the switch circuit 305. To maintain isolation between the primary and secondary sides of the power adapter, the detection signal 325 may be a non-electrical signal, such as an optical signal, magnetic signal, etc.

The switch circuit 305 includes a first terminal and a second terminal that may correspond to the first line terminal 219 and the output terminal 223 of the controller circuit 205. The switch circuit 305 is configured to receive the device detection signal 325 from the detector 315. When the device detection signal 325 is received, the switch circuit 305 closes, thus routing converter current 212 from the first terminal 219 to the second terminal 223. This in turn activates the converter 210. When the device detection signal 325 is removed, the switch circuit 305 opens, blocking converter current 212 and deactivating the converter 210.

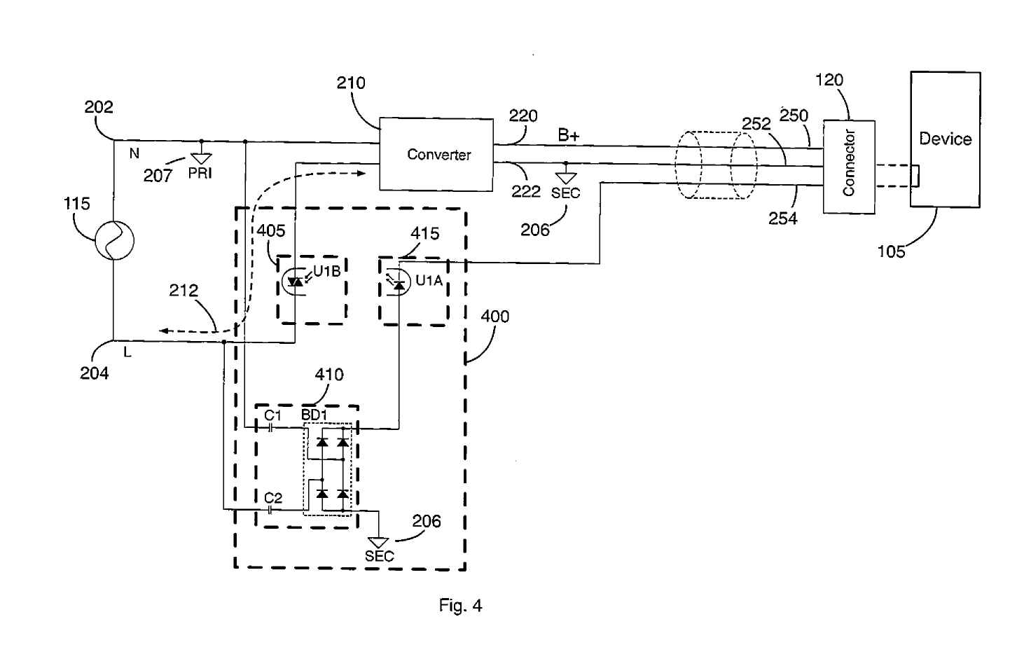

FIG. 4 is an exemplary schematic representation of a controller circuit 400 that may correspond to the controller circuit 300, described above. Referring to FIG. 4, the controller circuit 400 includes a switch circuit 405, a power circuit 410, and a detector circuit 415. The respective circuits may perform the same functions as the switch circuit 305, power circuit 310, and detector circuit 315, described above.

The power circuit 410 includes bridge rectifier BD1, which is configured to rectify AC voltage from the power source 115. The rectified voltage is communicated to the detector 415. The rectified voltage is referenced to a secondary ground 206. The secondary ground 206 is isolated from the first and second lines (202, 204) of the power source 115, because the voltage is communicated to the rectifier circuit BD1 via capacitors C1 and C2.

The switch circuit 405 and detector circuit 415 correspond to different portions of optical triac U1. The switch 405 corresponds to triac portion U1B and the detector circuit 415 corresponds to LED portion U1A. It is understood that a discrete triac and LED may be substituted. Triac U1B is configured to close or conduct when a device detection signal 325 (i.e., light radiation from the LED U1A) is received and to remain in an open or non-conductive state when the device detection signal 325 is not present (i.e., the LED is off). When closed, triac U1B allows current to flow between its terminals.

The anode of LED U1A is driven by the rectified voltage of the power circuit 310. The cathode of LED U1A is in electrical communication with the connector detection terminal 254. In one implementation, the connector detection terminal 254 is configured to be coupled to a shield terminal of a device 105 into which the connector 120 is configured to be inserted. In such devices, the shield terminal is typically coupled to a ground plane within the device 105. The ground plane is coupled to a power ground terminal, which is coupled to the ground terminal 252 of the connector 120. Thus, connection of the device 105 to the connector 120 causes the connector detection terminal 254 to short with the connector ground terminal 252. This in turn provides a path for the detection current to flow, which causes LED UA1 to activate. The detection current may be below 150 μA, 15 μA, or preferably less than 5 μA. When the device 105 is removed, the short is removed and LED UA1 deactivates.

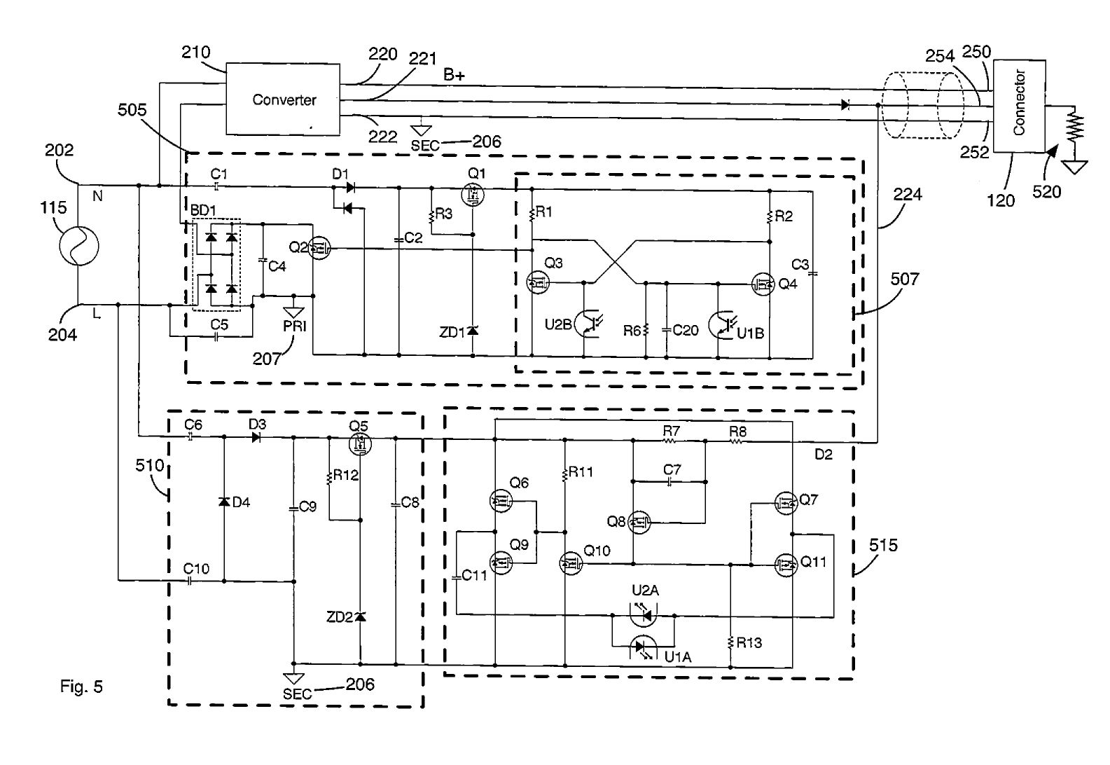

While detection via the shield is described, it is understood that the device 105 may be detected differently. For example, in alternate implementations, the connector detection terminal 254 may be configured to be coupled to a data line of the device 105 that is coupled to a resistor, which may be a pull-down resistor 520 to ground as illustrated in FIG. 5, a pull-up resister to a B+ voltage, or voltage divider network. Connection via such an implementation is described below.

Activation of LED UA1 causes triac U1B to close, which then allows converter current 212 to flow to the converter 210, thus activating the converter 210. Deactivation of LED UA1 causes triac U1B to open, which will block the converter current 212 and deactivate the converter 210.

As shown, current consumption by the controller circuit 400 in the standby state (i.e., when the device 105 is not connected) is minimized because LED U1A is not activated. Thus, the controller circuit 400 does not draw current during the standby state. Moreover, because triac U1B is open and the converter 210 is deactivated, the total current drawn by the power adapter 110 is limited to leakage current through triac U1B. The leakage current may be lower than 0.2 μA, which is of the same order of magnitude as the amount of leakage current associated with capacitive coupling between power lines of a typical six-foot power cord when connected to an AC terminal.

FIG. 5 is an exemplary schematic representation of a power adapter with a controller circuit that may correspond to the controller circuit 300, described above. Referring to FIG. 5, the controller circuit includes a switch circuit 505, a power circuit 510, and a detector circuit 515. The respective circuits may perform the same functions as the switch circuit 305, power circuit 310, and detector circuit 315, described above.

The power circuit 310 is configured to convert voltage from the power source 115 to a regulated DC voltage across capacitor C8. The regulated DC voltage is isolated from the power source by capacitors C6 and C10.

The detection circuit 515 is configured to detect a change in impedance on the connector detection terminal 254. For example, the connector detection terminal 254 may be floating when the connector 120 is not connected to a device 105 and thus have infinite impedance. In other implementations, the connector detection terminal 254 has a known impedance, and/or voltage. For example, a voltage divider network within the converter 210 that facilitates the determination of the type of converter 210 may be coupled to the connector detection terminal via a terminal 221 of the converter. When connected to the device 105, the connector detection terminal 254 may be coupled to, for example, a data line of the device 105, such a D+ or D− data line of a USB port. Such a data line may be connected to a pull-down resistor 520, a pull-up resistor, or a voltage divider resistor network between a positive voltage and ground.

In operation, when the connector detection terminal 254 is floating and thus in a high impedance state, transistor Q8 of the detection circuit 515 is in an off state. When the connector detection terminal 254 is connected to a data line with a resistor divider network or pull down resistor 520 to a voltage that is lower than the voltage provided by the power circuit 310, transistor Q8 will enter an on state. Toggling of transistor Q8 between an off state and an on state will switch either transistors Q6 and Q11 on, or transistors Q9 and Q7 on. When a change in state occurs, current will flow through capacitor C11 until capacitor C11 charges. Current flowing through capacitor C11 will activate either LED U1A or LED U2A of optical switches U1 and U2, depending on the direction of the charge current through capacitor C11, which is dependent on whether the impedance changed from low to high or vice-versa. Thus, the detection circuit 515 generates a momentary on signal and a momentary off signal (i.e., device detection signal 325) indicative of whether the device 105 was connected or removed. That is, the momentary on and off signals are only generated when the device transitions between connected and disconnected states. The momentary on and off signals may be active for 5 ms or less.

Main blocks of the switch circuit 405 include rectifier BD1, transistor Q2, and a toggle latch circuit 507. In operation, rectifier BD1 rectifies current from the first line terminal 204 so that it always flows towards the drain of transistor Q2. When transistor Q2 is activated (i.e., closed), the current flows back to rectifier BD1 and into the converter 210, which activates the converter.

Activation of transistor Q2 is controlled by the toggle latch circuit 507. The toggle latch circuit 507 is configured to receive the momentary on signal and the momentary off signal from the detection circuit 515 via optical switches U1 and U2. The momentary on signal causes the toggle latch circuit to activate and maintain activation of transistor Q2 until the momentary off signal is received. Likewise, the momentary off signal causes the toggle latch circuit to deactivate and maintain deactivation of transistor Q2 until the momentary on signal is received.

As shown, current consumption by the controller circuit is minimized because LEDs U1A and U2A are only activated momentarily, and the on or off state of transistor Q2 is maintained by the toggle latch circuit 507. While the toggle latch circuit 507 and power circuit 510 do draw some power when in standby, various components of the respective circuit may be chosen to minimize current. Thus, the leakage current associated with the power adapter may be lower than 0.2 μA, which is of the same order of magnitude as the amount of leakage current associated with capacitive coupling between power lines of a typical six-foot power cord when connected to an AC terminal.

While various embodiments have been described, it will be apparent to those of ordinary skill in the art that many more embodiments and implementations are possible that are within the scope of the claims. For example, while various elements are described as being coupled to one another, the term does not necessarily imply direct coupling.

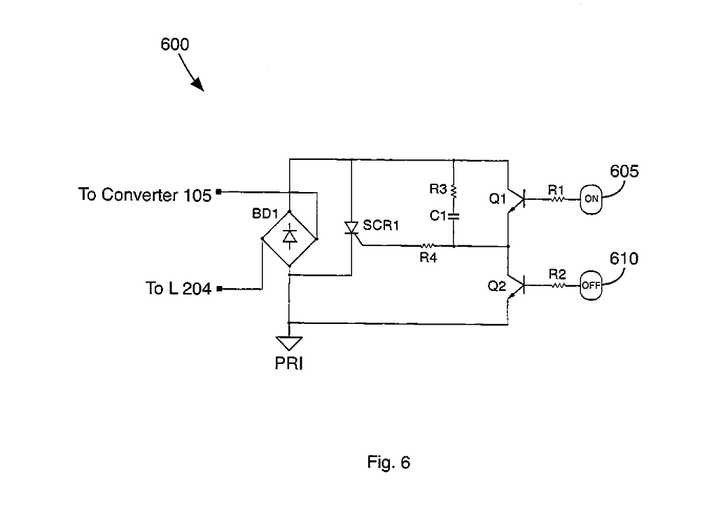

In alternate implementations, transistor Q2 of the switch circuit 505 of FIG. 5 may be replaced with silicon controlled rectifier SCR1 of the circuit 600, illustrated in FIG. 6. Transistors Q3 and Q4 of the toggle latch circuit 507 may be configured to drive the on and off inputs (605, 610) of the SCR circuit 600 rather than latch one another.

In yet alternate implementations, the detector circuit 515 of FIG. 5 may be replaced with the detector circuit 400 of FIG. 4. In this case, the toggle circuit 507 of FIG. 5 may be replaced with a single optical transistor that receives the detector signal from the detector circuit 400 and drives the gate input of transistor Q2 of the switch circuit 505 to thereby activate the converter 210.

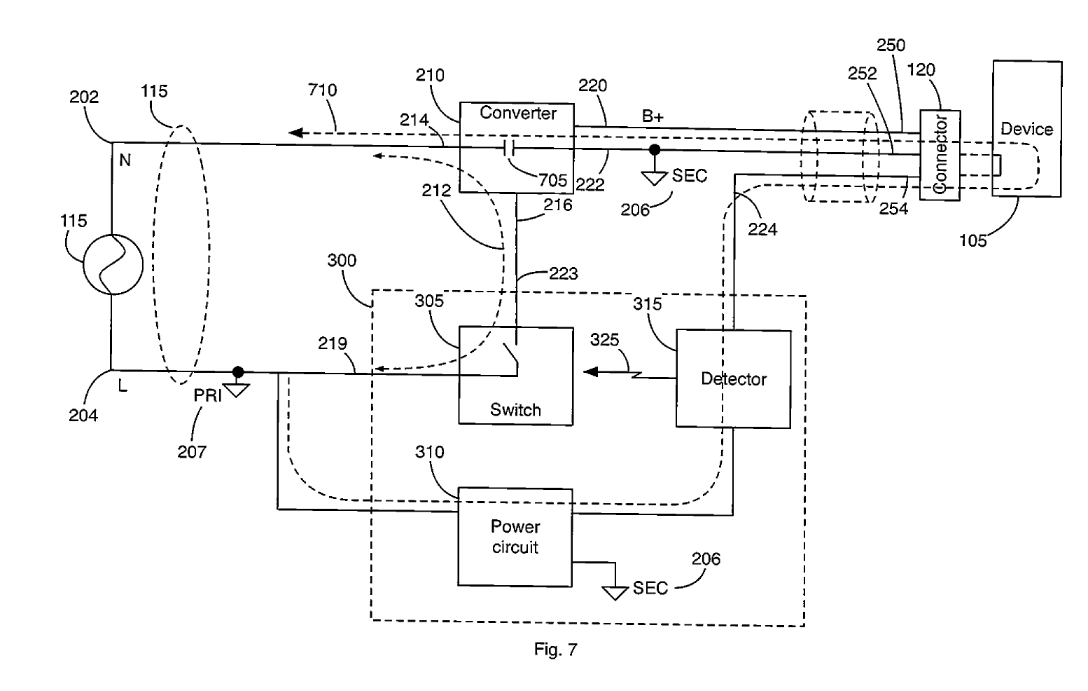

In yet other implementations, a single capacitor (e.g., C2 of FIG. 4, C6 of FIG. 5) may couple the power supply circuit (410, 510) to the power source 115 to minimize the number of components. For example, in the schematic of FIG. 4, capacitor Cl may be removed and bridge rectifier BD1 may be replaced by a single diode. In the schematic of FIG. 5, capacitor C10 may be removed and capacitor C6 may be coupled to the first line input 204 rather than the second line 202. In both cases, the return path for current that flows through the power supply circuit (410, 510) may be by way of one or more so-called Y-capacitors (FIG. 7, 705) and/or other parasitic capacitances within the converter (210) that couple the secondary ground 206 to the second line 202, as illustrated in FIG. 7. Referring to FIG. 7, with such modifications, when a device 105 is coupled to the connector 120, the detector current 710 flows from the power supply (410, 510) to the device 105, and then back from the device 105, through the converter Y-capacitor 705, and finally to the second line 202 of the power source 115. With techniques described above, a standby power of ˜80 μW with a 120VAC@60 Hz power source 115 can be achieved.

Other modifications may be made. For example, various intermediary elements may be added between the elements of the embodiments. The connector may be positioned on the power adapter rather than at the end of a cable. The controller circuit may be embodied in an integrated circuit and/or a combination of discrete and integrated components that are separate from the converter. The power adapter functionality may be wholly or partially incorporated within the device. Battery charging circuitry may be added to the power adapter to facilitate direct charging of a battery by the power adapter without the need for the device. The device may be detected via other means, such as optically, capacitively, and wirelessly. Any such modifications are understood to fall within the scope of protection afforded by the claims. Accordingly, it will be apparent to those of ordinary skill in the art that many more embodiments and implementations are possible that are within the scope of the claims. Therefore, the embodiments described are only provided to aid in understanding the claims and do not limit the scope of the claims.

What is claimed is:

1. An electrical power converter, comprising:
a first line terminal configured to be coupled to a first line of a power source and a second line terminal configured to be coupled to a second line of the power source;
a switch circuit that includes a first terminal and a second terminal, the first terminal being in electrical communication with the second line terminal, and the switch circuit being configured to selectively route current from the first terminal to the second terminal based on a device detection signal;
an electrical power converter circuit that includes (a) a primary side including a power input terminal that is in electrical communication with the first line terminal, (b) a secondary side that includes a power output terminal and a secondary ground terminal that are configured to provide power to a device via power and ground terminals of the device, and (c) a primary ground terminal that is in electrical communication with the second terminal of the switch; and
a detection circuit configured to determine whether the device is connected to the electrical power converter and, if connected, generates the device detection signal to thereby cause current to flow via the switch circuit to the electrical power converter to activate the electrical power converter circuit, wherein when the device is not connected, instantaneous power consumed by the electrical power converter does not exceed 2 mW.

2. The electrical power converter according to claim 1, wherein the primary side ground and the secondary side ground are electrically isolated from one another.

3. The electrical power converter according to claim 1, further comprising a power circuit in electrical communication with the power source, said power circuit configured to route power from the power source to the detection circuit.

4. The electrical power converter according to claim 1, wherein the detection circuit includes a detection terminal configured to be selectively coupled to a third terminal of the device, wherein the detection circuit determines that the device is connected when a detection current flows through the detection terminal into the device and back from the device via the secondary ground.

5. The electrical power converter according to claim 4, wherein the detection current is less than 150 μA.

6. The electrical power converter according to claim 4, wherein the third terminal corresponds to a shield terminal of the device.

7. The electrical power converter according to claim 4, wherein the third terminal corresponds to a data line terminal of a universal-serial-bus (USB) of the device.

8. The electrical power converter according to claim 1, wherein the detection circuit includes a detection terminal configured to be selectively coupled to a third terminal of the device with a known impedance, wherein the detection circuit determines that the device is connected based on a change in impedance of the detection terminal.

9. The electrical power converter according to claim 8, wherein a first device detection signal is communicated when the device is connected and a second device detection signal is communicated when the device is disconnected.

10. The electrical power converter according to claim 9, wherein the first device detection signal and the second device detection signal are only communicated when the device transitions between a connected and disconnected state.

11. The electrical power converter according to claim 1, wherein the device detection signal is an optical signal.

12. The electrical power converter according to claim 1, wherein when a device is not detected substantially no power is deliverable via the power output terminal of the electrical power converter.

13. The electrical power converter according to claim 1, wherein when the electrical power converter circuit is not activated a voltage across the power output terminals of the electrical power converter is substantially zero volts.

14. The electrical power converter according to claim 1, wherein the device is a mobile device.

15. The electrical power converter according to claim 1, wherein when the device is connected, a detection current flows from the first line of the power source through a first capacitor to the detection circuit and back to the second line of the power source via a second capacitance positioned within the electrical power converter.

16. The electrical power converter according to claim 1, wherein the switch circuit includes a solid-state switch.

17. A system that includes a device and a power adapter for powering the device, the power adapter comprising:
an electrical power converter configured to power the device;
a controller circuit configured to activate and deactivate the electrical power converter based on a detection signal; and
a detection circuit configured to determine whether the device is connected to the electrical power converter and, if connected, generates the detection signal to thereby cause the controller circuit to activate the electrical power converter, wherein when the device is not detected, the electrical power converter circuit is not activated.

18. The system according to claim 17, wherein the electrical power converter includes power input terminals on a primary side and power output terminals on a secondary side and wherein a primary side ground and a secondary side ground are electrically isolated from one another.

19. The system according to claim 17, further comprising a power circuit in electrical communication with a power source from which the electrical power converter derives power configured to route power from the power source to the detection circuit.

20. The system according to claim 17, wherein the detection circuit includes a detection terminal configured to be selectively coupled to a third terminal of the device, wherein the detection circuit determines that the device is connected when a detection current flows through the detection terminal into the device and back from the device via the secondary ground.

21. The system according to claim 17, wherein a detection current drawn by the detection circuit is less than 150 μA.

22. The system according to claim 20, wherein the third terminal corresponds to a shield terminal of the device.

23. The system power converter according to claim 20, wherein the third terminal corresponds to a data line terminal of a universal-serial-bus (USB) of the device.

24. The system according to claim 17, wherein the detection circuit includes a detection terminal configured to be selectively coupled to a third terminal of the device with a known impedance, wherein the detection circuit determines that the device is connected based on a change in impedance of the detection terminal.

25. The system according to claim 24, wherein a first device detection signal is communicated when the device is connected and a second device detection signal is communicated when the device is disconnected.

26. The system according to claim 25, wherein the first device detection signal and the second device detection signal are only communicated when the device transitions between a connected and disconnected state.

27. The system according to claim 17, wherein the detector circuit communicates an optical device detection signal to the controller circuit to cause the controller circuit to activate the electrical power converter.

28. The system according to claim 17, wherein when a device is not detected substantially no power is deliverable via power output terminals of the electrical power converter.

29. The system according to claim 17, wherein when the device is connected, a detection current flows from a first line of a power source through a first capacitor to the detection circuit and back to a second line of the power source via a second capacitance positioned within the electrical power converter.

30. The system according to claim 17, wherein when the electrical power converter circuit is not activated a voltage across the power output terminals of the electrical power converter is substantially zero volts.

31. The system according to claim 17, wherein the switch circuit includes a solid-state switch.
